(19) United States
(12) Patent Application Publication
(10) Pub. No.: US 2023/0004780 A1
(43) Pub. Date: Jan. 5, 2023

(54) Multi-time Scale Model Predictive Control of Wastewater Treatment Process

(71) Applicant: BEIJING UNIVERSITY OF TECHNOLOGY, BEIJING (CN)

(72) Inventors: Honggui Han, BEIJING (CN); Shijia Fu, BEIJING (CN); Haoyuan Sun, BEIJING (CN); Junfei Qiao, BEIJING (CN)

(21) Appl. No.: 17/678,998

(22) Filed: Feb. 23, 2022

(30) Foreign Application Priority Data
Jun. 30, 2021 (CN) 202110733306.8

(51) Int. Cl. G06N 3/04; G06N 3/063; G06N 3/08; C02F 1/00

(52) U.S. Cl. CPC G06N 3/0436; G06N 3/0454; G06N 3/063; G06N 3/08; C02F 1/008; C02F 2209/15; C02F 2209/22; C02F 2209/001; C02F 2209/006

(57) ABSTRACT

A multi-time scale model predictive control method for wastewater treatment process is designed to control the dissolved oxygen concentration and nitrate nitrogen concentration in different time scales to ensure that the effluent quality meets the standard. In view of the difference of time scales in wastewater treatment process caused by different sampling periods of dissolved oxygen concentration and nitrate nitrogen concentration, prediction models with different time scales are firstly designed to unify the prediction outputs to the fast time scale. Then, the gradient descent algorithm is used to solve the optimal solution with fast time scale to control the wastewater treatment system. It not only conforms to the operation characteristics of wastewater treatment process, but also solves the problem of poor operation performance of multiobjective model predictive control caused by different time scales. The experimental results show that the multi-time scale model predictive control method can achieve accurate on-line control of dissolved oxygen concentration and nitrate nitrogen concentration with fast time scales.

### CROSS-REFERENCE TO RELATED APPLICATION

This application claims the priority benefits to Chinese Patent Application No. 202110733306.8 filed on Jun. 30, 2021, the content of which is hereby incorporated by reference in its entirety.

### TECHNOLOGY AREA

In this invention, the different time scale prediction models are used to predict the dissolved oxygen concentration and nitrate nitrogen concentration of wastewater treatment process in real time online in a fast time scale, and the control laws are calculated in the fast time scale to realize the accurate control of dissolved oxygen concentration and nitrate nitrogen concentration. As an important part of wastewater treatment process, the control of dissolved oxygen concentration and nitrate nitrogen concentration is an important branch of advanced manufacturing technology, which belongs to the field of intelligent control and water treatment.

### TECHNOLOGY BACKGROUND

The discharged wastewater contains a lot of organic matter, nitrogen, phosphorus and other substances, which is the main reason of water pollution. Wastewater treatment plant is one of the important ways to purify wastewater and realize the recycling of water resources. With the increasingly strict wastewater discharge standards, the control requirements for wastewater treatment process are also increasing. wastewater treatment process, as a complex process, has the characteristics of uncertainty, nonlinearity, time scale difference and so on. After years of construction, China's wastewater treatment industry has obtained lots of achievements. However, the backward production technology and extensive management mode make most wastewater treatment plants have high treatment cost and low efficiency. Therefore, it is an urgent problem to reduce energy consumption and improve wastewater treatment efficiency on the premise that the effluent quality of wastewater treatment plant meets the standard at this stage.

The concentration of dissolved oxygen in aerobic zone and nitrate nitrogen in anoxic zone of wastewater treatment process directly reflect the process of nitrification and denitrification. Controlling the dissolved oxygen concentration and nitrate nitrogen concentration within an appropriate range can improve the wastewater treatment capacity and ensure that the effluent quality meets the standard. Therefore, it is very important to control the dissolved oxygen concentration and nitrate nitrogen concentration in wastewater treatment process. However, due to the limitation of measuring instruments, the sampling periods of dissolved oxygen concentration and nitrate nitrogen concentration are different, which has the characteristics of inconsistent time scales. Meanwhile, the control of wastewater treatment process is difficult because the complexity of the physical, chemical and biological phenomena and the fluctuation of the influent flow and components. Traditional PID controller or nonlinear model predictive control cannot adapt to the above characteristics, which may reduce the system performance and wastewater treatment efficiency, and even difficult to maintain the stability of the closed-loop system.

The invention designs an multi-time scale model predictive control method for wastewater treatment process. In this method, different time scale prediction models are introduced to unify the prediction outputs of dissolved oxygen concentration and nitrate nitrogen concentration to the fast time scale, and the gradient descent algorithm is used to solve the control law on the fast time scale to realize the accurate on-line control of dissolved oxygen concentration and nitrate nitrogen concentration in the fast time scale.

### SUMMARY

In view of the difference of time scales in wastewater treatment process caused by different sampling periods of dissolved oxygen concentration and nitrate nitrogen concentration, the invention proposes a multi-time scale model predictive control method for wastewater treatment process. Prediction models with different time scales are designed to unify the prediction outputs to the fast time scale and the gradient descent algorithm is used to solve the optimal solution with fast time scale to control the wastewater treatment process system. The invention solves the problem of poor operation performance of multivariable model predictive control for multi time scale system and effectively improves the accuracy of online control of dissolved oxygen concentration and nitrate nitrogen concentration; The invention adopts the following technical scheme and implementation steps:

1. A multi-time scale model predictive control method of wastewater treatment process, comprising the following steps:

(1) the multi-time scale model predictive control system for wastewater treatment process control comprising a set of measuring devices arranged to obtain a dataset, measuring devices include dissolved oxygen detector, nitrate nitrogen detector, the dataset comprises a plurality of process variables related to a parameter of wastewater treatment process; a programmable logic controller arranged to perform digital/analog conversion and analog/digital conversion; a variable-frequency drive arranged to control the air-blower and electronic valve by changing the working power frequency of motor; an air-blower arranged to provide the required oxygen to the microorganisms in the wastewater treatment process; an electronic valve arranged to adjust internal return flow; a multi-time scale model predictive control module arranged to calculate the control law to track the dissolved oxygen concentration and nitrate nitrogen concentration in wastewater treatment process with different time scales; the multi-time scale model predictive control module comprising two fuzzy neural network to predict the system outputs, a time scale conversion mechanism to unify the prediction time scales to fast time scale, and an optimization control module to calculate the control law;

(2) the time scales of dissolved oxygen concentration and nitrate nitrogen concentration in wastewater treatment process are different, specifically:

T_{f} is the sampling interval of dissolved oxygen concentration, T_{f}∈[6, 10] is a positive integer in minutes, t_{f}=fT_{f} represents the sampling instant of dissolved oxygen concentration, f is the number of sampling steps of dissolved oxygen concentration, and f∈[1, 1000] is a positive integer;

Tₛ is the sampling interval of nitrate nitrogen concentration, Tₛ∈[12, 20] is a positive integer in minutes, tₛ=sTₛ represents the sampling instant of nitrate nitrogen concentration, s is the number of sampling steps of nitrate nitrogen concentration, and s∈[1, 400] is a positive integer;

ζ is the maximum common divisor of T_{f} and Tₛ, t_{η}=ηζ is the prediction instant of slow sampling fuzzy neural network, η is the number of prediction steps of slow sampling fuzzy neural network, η∈[1, 2000] is a positive integer;

(3) a fast sampling fuzzy neural network is designed to predict dissolved oxygen concentration with time scale T_{f}, which is as follows:

the input of the fast sampling fuzzy neural network is x_{f}(t_{f})=[x_{f1}(t_{f-1}), x_{f2}(t_{f-1}), x_{f3}(t_{f-1})]^{T}, T is the transposition of the matrix, and the output of the fast sampling fuzzy neural network is the predicted value of dissolved oxygen concentration ŷ_{f}(t_{f}) at time t_{f}, the output is defined as follows

$${\hat{y}}_{f} ( {t}_{f} ) = \frac{{\sum }_{j = 1}^{6} {w}_{fj} ( {t}_{f} ) {e}^{- {\sum }_{i = 1}^{3} \frac{{( {x}_{fi} ( {t}_{f} - 1 ) - {c}_{fij} ( {t}_{f} ) )}^{2}}{2 {σ}_{fij}^{2} ( {t}_{f} )}}}{{\sum }_{j = 1}^{6} {e}^{- {\sum }_{i = 1}^{3} \frac{{( {x}_{fi} ( {t}_{f} - 1 ) - {c}_{fij} ( {t}_{f} ) )}^{2}}{2 {σ}_{fij}^{2} ( {t}_{f} )}}} \qquad ( 1 )$$

where x_{f}(t_{f-1}) is the ith input of the fast sampling fuzzy neural network at time t_{f}, i=1, 2, 3, w_{fj}(t_{f}) is the weight between the jth regular layer neuron and the output layer neuron of the fast sampling fuzzy neural network at time t_{f}, w_{fj}(t₀) is randomly assigned within [0, 1], j=1, 2, 3, 4, 5, 6, t₀ is the initial instant, c_{fij}(t_{f}) is the center of the ith input neuron corresponding to the jth radial basis function neuron of the fast sampling fuzzy neural network at time t_{f}, σ_{fij}(t₀) is randomly assigned within [0,1], σ_{fij}(t_{f}) is the width of the ith input neuron corresponding to the jth radial basis function neuron of the fast sampling fuzzy neural network at time t_{f}, and σ_{fij}(t₀) is randomly assigned within [0,1];

(4) a slow sampling fuzzy neural network is designed to predict nitrate nitrogen concentration with time scale ζ, which is as follows:

The input of the slow sampling fuzzy neural network is xₛ(t_{η})=[xₛ₁(t_{η-1}), xₛ₂(t_{η-1}), xₛ₃(t_{η-1})]^{T}, and the output of the slow sampling fuzzy neural network is the predicted value of nitrate nitrogen concentration ŷₛ(t_{η}) at time t_{η}, the output is defined as follows

$${\hat{y}}_{f} ( {t}_{η} ) = \frac{{\sum }_{j = 1}^{6} {ω}_{sj} ( {t}_{η} ) {e}^{- {\sum }_{i = 1}^{3} \frac{{( {x}_{si} ( {t}_{η} - 1 ) - {c}_{sij} ( {t}_{η} ) )}^{2}}{2 {σ}_{sij}^{2} ( {t}_{η} )}}}{{\sum }_{j = 1}^{6} {e}^{- {\sum }_{i = 1}^{3} \frac{{( {x}_{si} ( {t}_{η} - 1 ) - {c}_{sij} ( {t}_{η} ) )}^{2}}{2 {σ}_{sij}^{2} ( {t}_{η} )}}} \qquad ( 2 )$$

where xₛᵢ(t_{η-1}) is the ith input of the slow sampling fuzzy neural network at time t_{η}, wₛⱼ(t_{η}) is the weight between the jth regular layer neuron and the output layer neuron of the slow sampling fuzzy neural network at time t_{η}, wₛⱼ(t₀) is randomly assigned within [0, 1], σₛᵢⱼ(t_{η}) is the center of the ith input neuron corresponding to the jth radial basis function neuron of the slow sampling fuzzy neural network at time t_{η}, cₛᵢⱼ(t₀) is randomly assigned within [0,1], σₛᵢⱼ(t_{η}) is the width of the ith input neuron corresponding to the jth radial basis function neuron of the slow sampling fuzzy neural network at time t_{η}, and σₛᵢⱼ(t₀) is randomly assigned within [0,1];

a dataset Ω whose time scale is ζ is constructed as follows, when tₛ≤t_{η}<tₛ₊₁:

uₛ₁^{η}(t_{η})=uₛ₁(tₛ) (3)

uₛ₂^{η}(t_{η})=uₛ₂(tₛ) (4)

yₛ^{η}(t_{η})=yₛ(tₛ)+Tₛ(yₛ(tₛ₊₁)−yₛ(tₛ))/t_{η} (5)

where uₛ₁^{η}(t_{η}) is the virtual value of aeration rate at time t_{η}, uₛ₁(tₛ) is the actual value of aeration rate at time tₛ, uₛ₂^{η}(t_{η}) is the virtual value of internal reflux at time t_{η}, uₛ₂(tₛ) is the actual value is of internal reflux at time tₛ, yₛ^{η}(t_{η}) is the virtual estimated value of nitrate nitrogen concentration at time t_{η}, yₛ(tₛ) is the actual value of the nitrate nitrogen concentration converted by the programmable logic controller at time tₛ, yₛ(tₛ₊₁) is the actual value of the nitrate nitrogen concentration converted by the programmable logic controller at time tₛ₊₁; the dataset Ω is composed of uₛ₁^{η}(t_{η}), uₛ₂^{η}(t_{η}), and yₛ^{η}(t_{η});

The dataset Ω is used to pre-train the slow sampling fuzzy neural network offline, and the training input is xₛ^{η}(t_{η})=[yₛ^{η}(t_{η-1}), uₛ₁^{η}(t_{η-1}), uₛ₂^{η}(t_{η-1})]^{T}, yₛ^{η}(t_{η-1}) is the nitrate nitrogen concentration at time t_{η-1} in Ω, uₛ₁^{η}(t_{η-1}) is the aeration rate at time t_{η-1} in Ω, uₛ₂ (t_{η-1}) is the internal reflux at time t_{η-1} in Ω, the training output is the prediction value of nitrate nitrogen concentration ŷₛ^{η}(t_{η}) at time t_{η}; using the error between nitrate nitrogen concentration value in dataset Ω and predicted value Eₛ^{η}(t_{η})=½[yₛ^{η}(t_{η})−ŷₛ^{η}(t_{η})]² at time t_{η}, correct parameters of slow sampling fuzzy neural network:

wₛⱼ(t_{η+1})=wₛⱼ(t_{η})−0.2∂Eₛ^{η}(t_{η})/∂wₛⱼ(t_{η}) (6)

cₛᵢⱼ(t_{η+1})=cₛᵢⱼ(t_{η})−0.2Eₛ^{η}(t_{η})/∂cₛᵢⱼ(t_{η}) (7)

σₛᵢⱼ(t_{η+1})=σₛᵢⱼ(t_{η})−0.2∂Eₛ^{η}(t_{η})/∂σₛᵢⱼ(t_{η}) (8)

where wₛⱼ(t_{η+1}) is the weight between the jth regular layer neuron and the output layer neuron of the slow sampling fuzzy neural network at time t_{η+1}, cₛᵢⱼ(t_{η+1}) is the center of the ith input neuron corresponding to the jth radial basis function neuron of the slow sampling fuzzy neural network at time t_{η+1}, σₛᵢⱼ(t_{η+1}) is the width of the ith input neuron corresponding to the jth radial basis function neuron of the slow sampling fuzzy neural network at time t_{η+1};

(5) The multi-time scale model predictive control method is designed to control the dissolved oxygen concentration and nitrate nitrogen concentration in time scale T_{f}, specifically:

\textcircled{1} set s=1, f=1, η=1;

\textcircled{2} according to the sampling information converted by programmable logic controller, predict nitrate nitrogen concentration at time t_{η} using slow sampling fuzzy neural network; the inputs of the slow sampling fuzzy neural network are as follows: xₛ₁(t_{η-1}) is the actual value of nitrate nitrogen concentration yₛ(t_{η-1}) at time t_{η-1}, xₛ₂(t_{η-1}) is the aeration rate u₁(t_{η-1}) at time t_{η-1}, xₛ₃(t_{η-1}) is the internal reflux u₂(t_{η-1}) at time t_{η-1}; the output of the slow sampling fuzzy neural network is the prediction value of nitrate nitrogen concentration ŷₛ(t_{η}) at time t_{η};

\textcircled{3} if t_{η}=t_{f}, set ŷₛ(t_{f})=fₛ(t_{η}), where ŷₛ(t_{f}) is the prediction value of nitrate nitrogen concentration at time t_{f}, go to step \textcircled{6} after performing step \textcircled{4}; if t_{η}≠t_{f}, go to step \textcircled{6} after performing step \textcircled{5};

\textcircled{4} if t_{η}=tₛ, increase the value of s by 1, update the parameters of the slow sampling fuzzy neural network by the error between the predicted value and the actual value of nitrate nitrogen concentration Eₛ(t_{η})=½[yₛ(tₛ)−ŷₛ(t_{η})]²:

wₛⱼ(t_{η+1})=wₛⱼ(t_{η})−0.2∂Eₛ(t_{η})/∂wₛⱼ(t_{η}) (9)

cₛᵢⱼ(t_{η+1})=cₛᵢⱼ(t_{η})−0.2∂Eₛ(t_{η})/∂cₛᵢⱼ(t_{η}) (10)

σₛᵢⱼ(t_{η+1})=σₛᵢⱼ(t_{η})−0.2∂Eₛ(t_{η})/∂σₛᵢⱼ(t_{η}) (11)

if t_{η}≠tₛ, the parameters of slow sampling fuzzy neural network are not updated;

\textcircled{5} set yₛ(t_{η})=ŷₛ(t_{η}), u₁(t_{η})=u₁(t_{f}), u₂(t_{η})=u₂(t_{f}), increase the value of η by 1, go to step \textcircled{2}, where yₛ(t_{η}) is the actual nitrate nitrogen concentration converted by the programmable logic controller at time t_{η}, u₁(t_{η}) is the aeration rate at time t_{η}, u₂(t_{η}) is the internal reflux at time t_{η}, u₁(t_{f}) is the aeration rate at time t_{f}, u₂(t_{f}) is the internal reflux at time t_{f};

\textcircled{6} predict dissolved oxygen concentration at time t_{f} by the fast sampling fuzzy neural network; the inputs of the fast sampling fuzzy neural network are as follows: x_{f1}(t_{f-1}) is the actual value of dissolved oxygen concentration ŷ_{f}(t_{f-1}) converted by the programmable logic controller at time t_{f-1}, x_{f2}(t_{f-1}) is the aeration rate u₁(t_{f-1}) at time t_{f-1}, x_{f3}(t_{f-1}) is the internal reflux u₂(t_{f-1}) at time t_{f-1}; the output of the fast sampling fuzzy neural network is the prediction value of dissolved oxygen concentration ŷ_{f}(t_{f}) at time t_{f}; update the parameters of the fast sampling fuzzy neural network by the error between the predicted value and the actual value of dissolved oxygen concentration E_{f}(t_{f})=½[y_{f}(t_{f})−ŷ_{f}(t_{f})]²:

w_{fj}(t_{f+1})=w_{fj}(t_{f})−0.2∂E_{f}(t_{f})/∂w_{fj}(t_{f}) (12)

c_{fij}(t_{f+1})=c_{fij}(t_{f})−0.2∂E_{f}(t_{f})/∂c_{fij}(t_{f}) (13)

σ_{fij}(t_{f+1})=σ_{fij}(t_{f})−0.2∂E_{f}(t_{f})/∂σ_{fij}(t_{f}) (14)

where w_{fj}(t_{f+1}) is the weight between the jth regular layer neuron and the output layer neuron of the slow sampling fuzzy neural network at time t_{f+1}, c_{fij}(t_{f+1}) is the center of the ith input neuron corresponding to the jth radial basis function neuron of the fast sampling fuzzy neural network at time t_{f+1}, σ_{fij}(t_{f+1}) is the width of the ith input neuron corresponding to the jth radial basis function neuron of the fast sampling fuzzy neural network at time t_{f+1};

\textcircled{7} design an objective function of multi-time scale model predictive control to track the set-points of nitrate nitrogen concentration and dissolved oxygen concentration, and calculate the control law at time t_{f}:

J(t_{f})=0.25[[r_{f}(t_{f})−ŷ_{f}(t_{f})]^{T}[r_{f}(t_{f})−ŷ_{f}(t_{f})]+Δu(t_{f})^{T}Δu(t_{f})]+0.45[rₛ(t_{f})−ŷₛ(t_{f})]^{T}[rₛ(t_{f})−ŷₛ(t_{f})]+Δu(t_{f})^{T}Δu(t_{f}) (15)

where r_{f}(t_{f})=[r_{f}(t_{f+1}), r_{f}(t_{f+2}), r_{f}(t_{f+3})]^{T} is the set-point of dissolved oxygen concentration, r_{f}(t_{f+1})=2 mg/l represents the set-point of dissolved oxygen concentration at time t_{f+1}, r_{f}(t_{f+2})=2 mg/l represents the set-point of dissolved oxygen concentration at time t_{f+2}, r_{f}(t_{f+3})=2 mg/l represents the set-point of dissolved oxygen concentration at time t_{f+3}; ŷ_{f}(t_{f})=[ŷ_{f}(t_{f+1}), ŷ_{f}(t_{f+2}), ŷ_{f}(t_{f+3})]^{T} is the prediction output of the fast sampling fuzzy neural network, ŷ_{f}(t_{f-1}) is the prediction value of dissolved oxygen concentration at time t_{f+1}, ŷ_{f}(t_{f+2}) is the prediction value of dissolved oxygen concentration at time t_{f+2}, ŷ_{f}(t_{f+3}) is the prediction value of dissolved oxygen concentration at time t_{f+3}; rₛ(t_{f})=[rₛ(t_{f+1}), rₛ(t_{f+2}), rₛ(t_{f+3})]^{T} is the set-point of nitrate nitrogen concentration; rₛ(t_{f+1})=1 mg/l represents the set-point of nitrate nitrogen concentration at time t_{f+1}, rₛ(t_{f+2})=1 mg/l represents the set-point of nitrate nitrogen concentration at time t_{f+2}, rₛ(t_{f+3})=1 mg/l represents the set-point of nitrate nitrogen concentration at time t_{f+3}; ŷₛ(tₛ)=[ŷₛ(tₛ₊₁), ŷₛ(tₛ₊₂), ŷₛ(tₛ₊₃)]^{T} is the prediction output of slow sampling fuzzy neural network, ŷₛ(t_{f-1}) is the prediction value of nitrate nitrogen concentration at time t_{f+1}, ŷₛ(t_{f+2}) is the prediction value of nitrate nitrogen concentration at time t_{f+2}, ŷₛ(t_{f+3}) is the prediction value of nitrate nitrogen concentration at time t_{f+3}; Δu(t_{f})=[Δu₁(t_{f}), Δu₂(t_{f})]^{T} is the incremental control moves at time t_{f}, Δu₁(t_{f}) is the aeration rate adjustment amount at time t_{f}, Δu₂(t_{f}) is the internal reflux adjustment amount at time t_{f}, where

Δu(t_{f})=u(t_{f+1})−u(t_{f}) (16)

|Δu(t_{f})|≤Δuₘₐₓ (17)

u(t_{f})=[u₁(t_{f}), u₂(t_{f})]^{T} is control vector converting into analog signal through programmable logic controller and transmitting to variable frequency driver at time t_{f}, u(t_{f-1})=[u₁(t_{f-1}), u₂(t_{f-1})]^{T} is control vector converting into analog signal through programmable logic controller and transmitting to variable frequency driver at time t_{f+1}, u₁(t_{f-1}) is the aeration rate at time t_{f+1}, u₂(t_{f+1}) is the internal reflux at time t_{f+1}; Δuₘₐₓ=[ΔK_{L}aₘₐₓ, ΔQₐₘₐₓ]^{T} is the maximum adjustment vector allowed by the controller, ΔK_{L}aₘₐₓ=100 L/min is the maximum aeration adjustment amount, ΔQₐₘₐₓ=50000 L/min is the maximum internal reflux adjustment amount, Δuₘₐₓ is set through the blower and internal reflux valve in the control system equipment;

an aeration rate and internal reflux adjustment vector are calculated by minimizing Eq.(15):

$$Δ u ( {t}_{f} ) = ( 0. 4 {( \frac{\partial {\hat{y}}_{f} ( {t}_{f} )}{\partial u ( {t}_{f} )} )}^{T} [ {r}_{f} ( {t}_{f} ) - {\hat{y}}_{f} ( {t}_{f} ) ] + 0.08 {( \frac{\partial {\hat{y}}_{s} ( {t}_{f} )}{\partial u ( {t}_{f} )} )}^{T} [ {r}_{s} ( {t}_{f} ) - {\hat{y}}_{s} ( {t}_{f} ) ] ) \qquad ( 18 )$$

adjust the aeration rate and internal reflux at time t_{f}:

u(t_{f+1})=u(t_{f})+Δu(t_{f}) (19)

\textcircled{8} if f≤1000, increase the value of f by 1, increase the value of η by 1, go to step \textcircled{2}; if f>1000, end the cycle;

(6) the concentration of nitrate nitrogen and dissolved oxygen is controlled by u(t_{f}), and u(t_{f})=[u₁(t_{f}), u₂(t_{f})]^{T} is transferred to programmable logic controller for digital/analog conversion to obtain U(t_{f})=[U₁(t_{f}), U₂(t_{f})]^{T}, which is the input of variable-frequency drive, the variable-frequency drive changes the working power frequency of motor to control the aeration pump and electronic valve, then, the aeration rate and internal reflux are controlled, the output of the system is the actual value of nitrate nitrogen concentration and dissolved oxygen concentration.

The Novelties of this Patent Contain:

(1) Aiming at the problem that the control variables of wastewater treatment process have different time scales, a multi-time scale model predictive control method is established to control the concentration of dissolved oxygen and nitrate nitrogen with fast time scale.

(2) To deal with the strong nonlinearity of wastewater treatment process, two fuzzy neural networks with different time scales are designed to model the concentration of dissolved oxygen and nitrate nitrogen, which solves the problem that the nonlinear system is difficult to model and obtains the prediction outputs of dissolved oxygen concentration and nitrate nitrogen concentration in the fast time scale.

(3) The invention introduced a gradient descent algorithm to solve the above multiobjective optimization problem, so as to calculate the control law.

(4) The multi-time scale model predictive control method in this invention has the characteristics of high precision, low energy consumption, strong stability, etc.

The invention adopts the model predictive control method to solve the control law in the fast time scale, realizes the accurate on-line control of dissolved oxygen concentration and nitrate nitrogen concentration, and has the characteristics of high precision, high efficiency, strong stability, etc;

Attention: for convenience of description, the invention only adopt the control of dissolved oxygen concentration and nitrate nitrogen concentration. The invention can also be used for the control of ammonia nitrogen in wastewater treatment process, etc. As long as the principle of the invention is adopted for control, it shall be the scope of the invention.

### DESCRIPTION OF DRAWINGS

FIG. 1 is diagram of the multi-time scale model predictive control system of wastewater treatment process.

FIG. 2 is a control structure diagram of the invention.

FIG. 3 is an algorithm diagram of the invention.

FIG. 4 is the time diagram of the invention.

FIG. 5 is the result diagram of the dissolved oxygen concentration control in this invention.

FIG. 6 is the error diagram of the dissolved oxygen concentration control result in this invention.

FIG. 7 is the result diagram of nitrate nitrogen concentration control in this invention.

FIG. 8 is the error diagram of the nitrate nitrogen concentration control result in this invention.

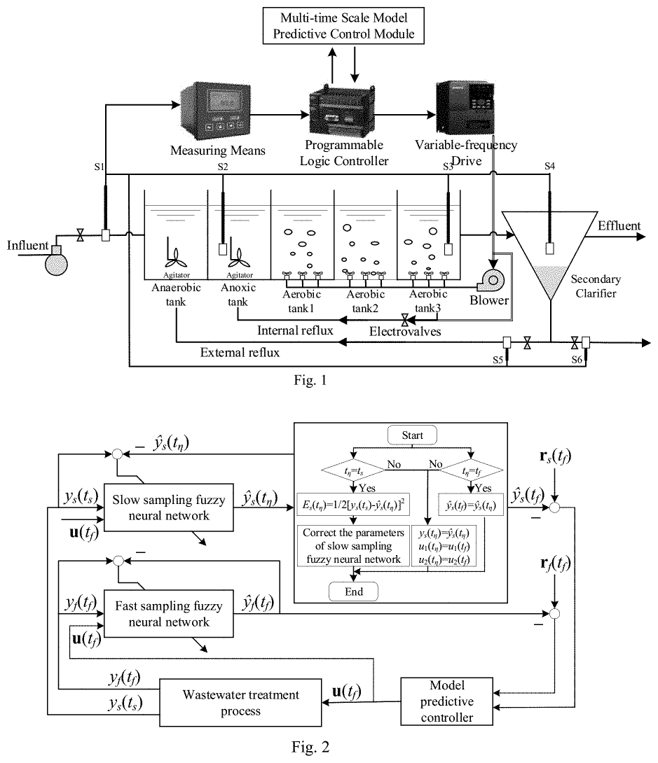

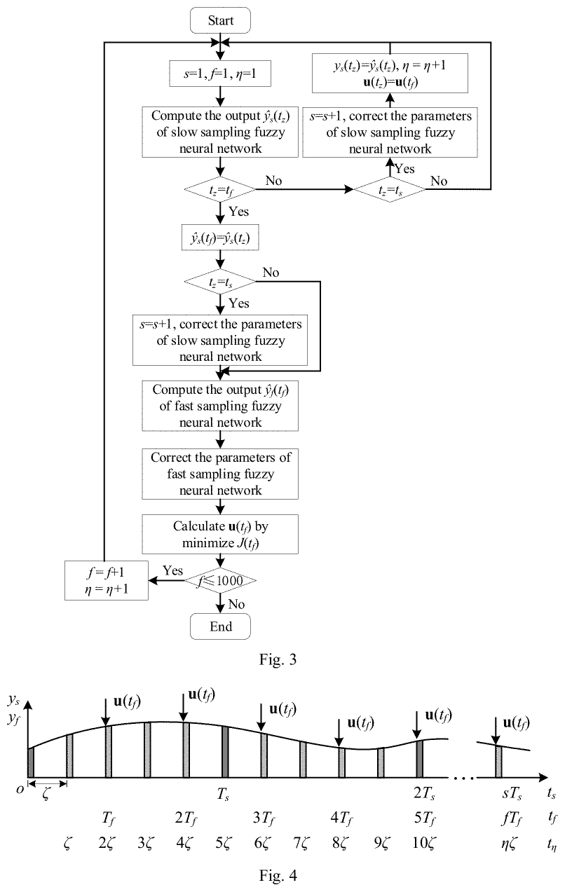

### DETAILED DESCRIPTION OF THE INVENTION

1. A multi-time scale model predictive control method of wastewater treatment process, comprising the following steps:

(1) the multi-time scale model predictive control system for wastewater treatment process control comprising a set of measuring devices arranged to obtain a dataset, measuring devices include dissolved oxygen detector, nitrate nitrogen detector, the dataset comprises a plurality of process variables related to a parameter of wastewater treatment process; a programmable logic controller arranged to perform digital/analog conversion and analog/digital conversion; a variable-frequency drive arranged to control the air-blower and electronic valve by changing the working power frequency of motor; an air-blower arranged to provide the required oxygen to the microorganisms in the wastewater treatment process; an electronic valve arranged to adjust internal return flow; a multi-time scale model predictive control module arranged to calculate the control law to track the dissolved oxygen concentration and nitrate nitrogen concentration in wastewater treatment process with different time scales; the multi-time scale model predictive control module comprising two fuzzy neural network to predict the system outputs, a time scale conversion mechanism to unify the prediction time scales to fast time scale, and an optimization control module to calculate the control law;

(2) the time scales of dissolved oxygen concentration and nitrate nitrogen concentration in wastewater treatment process are different, specifically:

T_{f} is the sampling interval of dissolved oxygen concentration, T_{f}∈[6, 10] is a positive integer in minutes, t_{f}=fT_{f} represents the sampling instant of dissolved oxygen concentration, f is the number of sampling steps of dissolved oxygen concentration, and f∈[1, 1000] is a positive integer;

Tₛ is the sampling interval of nitrate nitrogen concentration, Tₛ∈[12, 20] is a positive integer in minutes, tₛ=sTₛ represents the sampling instant of nitrate nitrogen concentration, s is the number of sampling steps of nitrate nitrogen concentration, and s∈[1, 400] is a positive integer;

ζ is the maximum common divisor of T_{f} and Tₛ, t_{η}=ηζ is the prediction instant of slow sampling fuzzy neural network, η is the number of prediction steps of slow sampling fuzzy neural network, η∈[1, 2000] is a positive integer;

(3) a fast sampling fuzzy neural network is designed to predict dissolved oxygen concentration with time scale T_{f}, which is as follows:

the input of the fast sampling fuzzy neural network is x_{f}(t_{f})=[x_{f1}(t_{f-1}), x_{f2}(t_{f-1}), x_{f3}(t_{f-1})]^{T}, T is the transposition of the matrix, and the output of the fast sampling fuzzy neural network is the predicted value of dissolved oxygen concentration ŷ_{f}(t_{f}) at time t_{f}, the output is defined as follows

$${\hat{y}}_{f} ( {t}_{f} ) = \frac{{\sum }_{j = 1}^{6} {w}_{fj} ( {t}_{f} ) {e}^{- {\sum }_{i = 1}^{3} \frac{{( {x}_{fi} ( {t}_{f} - 1 ) - {c}_{fij} ( {t}_{f} ) )}^{2}}{2 {σ}_{fij}^{2} ( {t}_{f} )}}}{{\sum }_{j = 1}^{6} {e}^{- {\sum }_{i = 1}^{3} \frac{{( {x}_{fi} ( {t}_{f} - 1 ) - {c}_{fij} ( {t}_{f} ) )}^{2}}{2 {σ}_{fij}^{2} ( {t}_{f} )}}} \qquad ( 20 )$$

where x_{fi}(t_{f-1}) is the ith input of the fast sampling fuzzy neural network at time t_{f}, i=1, 2, 3, w_{fj}(t_{f}) is the weight between the jth regular layer neuron and the output layer neuron of the fast sampling fuzzy neural network at time t_{f}, w_{fj}(t₀) is randomly assigned within [0, 1], j=1, 2, 3, 4, 5, 6, t₀ is the initial instant, c_{fij}(t_{f}) is the center of the ith input neuron corresponding to the jth radial basis function neuron of the fast sampling fuzzy neural network at time t_{f}, c_{fij}(t₀) is randomly assigned within [0,1], σ_{fij}(t_{f}) is the width of the ith input neuron corresponding to the jth radial basis function neuron of the fast sampling fuzzy neural network at time t_{f}, and σ_{fij}(t₀) is randomly assigned within [0,1];

(4) a slow sampling fuzzy neural network is designed to predict nitrate nitrogen concentration with time scale ζ, which is as follows:

The input of the slow sampling fuzzy neural network is xₛ(t_{η})=[xₛ₁(t_{η-1}), xₛ₂(t_{η-1}), xₛ₃(t_{η-1})]^{T}, and the output of the slow sampling fuzzy neural network is the predicted value of nitrate nitrogen concentration ŷₛ(t_{η}) at time t_{η}, the output is defined as follows

$${\hat{y}}_{f} ( {t}_{η} ) = \frac{{\sum }_{j = 1}^{6} {ω}_{sj} ( {t}_{η} ) {e}^{- {\sum }_{i = 1}^{3} \frac{{( {x}_{si} ( {t}_{η} - 1 ) - {c}_{sij} ( {t}_{η} ) )}^{2}}{2 {σ}_{sij}^{2} ( {t}_{η} )}}}{{\sum }_{j = 1}^{6} {e}^{- {\sum }_{i = 1}^{3} \frac{{( {x}_{si} ( {t}_{η} - 1 ) - {c}_{sij} ( {t}_{η} ) )}^{2}}{2 {σ}_{sij}^{2} ( {t}_{η} )}}} \qquad ( 21 )$$

where xₛᵢ(t_{η-1}) is the ith input of the slow sampling fuzzy neural network at time t_{η}, wₛⱼ(t_{η}) is the weight between the jth regular layer neuron and the output layer neuron of the slow sampling fuzzy neural network at time t_{η}, wₛⱼ(t₀) is randomly assigned within [0, 1], cₛᵢⱼ(t_{η}) is the center of the ith input neuron corresponding to the jth radial basis function neuron of the slow sampling fuzzy neural network at time t_{η}, cₛᵢⱼ(t₀) is randomly assigned within [0,1], σₛᵢⱼ(t_{η}) is the width of the ith input neuron corresponding to the jth radial basis function neuron of the slow sampling fuzzy neural network at time t_{η}, and σₛᵢⱼ(t₀) is randomly assigned within [0,1];

a dataset Ω whose time scale is ζ is constructed as follows, when tₛ≤t_{η}<tₛ₊₁.

uₛ₁^{η}(t_{η})=uₛ₁(tₛ) (22)

uₛ₂^{η}(t_{η})==uₛ₂(tₛ) (23)

yₛ^{η}(t_{η})=yₛ(tₛ)+Tₛ(yₛ(tₛ₊₁)−yₛ(tₛ))/t_{η} (24)

where uₛ₁^{η}(t_{η}) is the virtual value of aeration rate at time t_{η}, uₛ₁(tₛ) is the actual value of aeration rate at time tₛ, uₛ₂^{η}(t_{η}) is the virtual value of internal reflux at time t_{η}, uₛ₂(tₛ) is the actual value of internal reflux at time tₛ, yₛ^{η}(t_{η}) is the virtual estimated value of nitrate nitrogen concentration at time t_{η}, yₛ(tₛ) is the actual value of the nitrate nitrogen concentration converted by the programmable logic controller at time tₛ, yₛ(tₛ₊₁) is the actual value of the nitrate nitrogen concentration converted by the programmable logic controller at time tₛ₊₁; the dataset Ω is composed of uₛ₁^{η}(t_{η}), uₛ₂^{η}(t_{η}), and yₛ^{η}(t_{η});

The dataset Ω is used to pre-train the slow sampling fuzzy neural network offline, and the training input is xₛ^{η}(t_{η})=[yₛ^{η}(t_{η-1}), uₛ₁^{η}(t_{η-1}), uₛ₂^{η}(t_{η-1})]^{T}, yₛ^{η}(t_{η-1}) is the nitrate nitrogen concentration at time t_{η-1} in Ω, uₛ₁^{η}(t_{η-1}) is the aeration rate at time t_{η-1} in Ω, uₛ₂^{η}(t_{η-1}) is the internal reflux at time t_{η-1} in Ω, the training output is the prediction value of nitrate nitrogen concentration ŷₛ^{η}(t_{η}) at time t_{η}; using the error between nitrate nitrogen concentration value in dataset Ω and predicted value Eₛ^{η}(t_{η})=½[yₛ^{η}(t_{η})−ŷₛ^{η}(t_{η})]² at time t_{η}, correct parameters of slow sampling fuzzy neural network:

wₛⱼ(t_{η+1})=wₛⱼ(t_{η})−0.2∂Eₛ^{η}(t_{η})/∂wₛⱼ(t_{η}) (25)

cₛᵢⱼ(t_{η+1})=cₛᵢⱼ(t_{η})−0.2∂Eₛ^{η}(t_{η})/∂cₛᵢⱼ(t_{η}) (26)

σₛᵢⱼ(t_{η+1})=σₛᵢⱼ(t_{η})−0.2∂Eₛ^{η}(t_{η})/∂σₛᵢⱼ(t_{η}) (27)

where wₛⱼ(t_{η+1}) is the weight between the jth regular layer neuron and the output layer neuron of the slow sampling fuzzy neural network at time t_{η+1}, cₛᵢⱼ(t_{η+1}) is the center of the ith input neuron corresponding to the jth radial basis function neuron of the slow sampling fuzzy neural network at time t_{η+1}, σₛᵢⱼ(t_{η+1}) is the width of the ith input neuron corresponding to the jth radial basis function neuron of the slow sampling fuzzy neural network at time t+1;

(5) The multi-time scale model predictive control method is designed to control the dissolved oxygen concentration and nitrate nitrogen concentration in time scale T_{f}, specifically:

\textcircled{1} set s=1, f=1, η=1;

\textcircled{2} according to the sampling information converted by programmable logic controller, predict nitrate nitrogen concentration at time t_{η} using slow sampling fuzzy neural network; the inputs of the slow sampling fuzzy neural network are as follows: xₛ₁(t_{η-1}) is the actual value of nitrate nitrogen concentration yₛ(t_{η-1}) at time t_{η-1}, xₛ₂(t_{η-1}) is the aeration rate u₁(t_{η-1}) at time t_{η-1}, xₛ₃(t_{η-1}) is the internal reflux u₂(t_{η-1}) at time t_{η-1}; the output of the slow sampling fuzzy neural network is the prediction value of nitrate nitrogen concentration ŷₛ(t_{η}) at time t_{η};

\textcircled{3} if t_{η}=t_{f}, set ŷₛ(t_{f})=ŷₛ(t_{η}), where ŷₛ(t_{f}) is the prediction value of nitrate nitrogen concentration at time t_{f}, go to step \textcircled{6} after performing step \textcircled{4}; if t_{η}≠t_{f}, go to step \textcircled{6} after performing step \textcircled{5};

\textcircled{4} if t_{η}=tₛ, increase the value of s by 1, update the parameters of the slow sampling fuzzy neural network by the error between the predicted value and the actual value of nitrate nitrogen concentration Eₛ(t_{η})=½[yₛ(tₛ)−ŷₛ(t_{η})]²:

wₛⱼ(t_{η+1})=wₛⱼ(t_{η})−0.2∂Eₛ(t_{η})/∂wₛⱼ(t_{η}) (28)

cₛᵢⱼ(t_{η+1})=cₛᵢⱼ(t_{η})−0.2∂Eₛ(t_{η})/∂cₛᵢⱼ(t_{η}) (29)

σₛᵢⱼ(t_{η+1})=σₛᵢⱼ(t_{η})−0.2∂Eₛ(t_{η})/∂σₛᵢⱼ(t_{η}) (30)

if t_{η}≠tₛ, the parameters of slow sampling fuzzy neural network are not updated;

\textcircled{5} set yₛ(t_{η})=ŷₛ(t_{η}), u₁(t_{η})=u₁(t_{f}), u₂(t_{η})=u₂(t_{f}), increase the value of η by 1, go to step \textcircled{2}, where yₛ(t_{η}) is the actual nitrate nitrogen concentration converted by the programmable logic controller at time t_{η}, u₁(t_{θ}) is the aeration rate at time t_{η}, u₂(t_{θ}) is the internal reflux at time t_{η}, u₁(t_{f}) is the aeration rate at time t_{f}, u₂(t_{f}) is the internal reflux at time t_{f};

\textcircled{6} predict dissolved oxygen concentration at time t_{f} by the fast sampling fuzzy neural network; the inputs of the fast sampling fuzzy neural network are as follows: x_{f1}(t_{f-1}) is the actual value of dissolved oxygen concentration y_{f}(t_{f-1}) converted by the programmable logic controller at time t_{f-1}, x_{f2}(t_{f-1}) is the aeration rate u₁(t_{f-1}) at time t_{f-1}, x_{f3}(t_{f-1}) is the internal reflux u₂(t_{f-1}) at time t_{f-1}; the output of the fast sampling fuzzy neural network is the prediction value of dissolved oxygen concentration ŷ_{f}(t_{f}) at time t_{f}; update the parameters of the fast sampling fuzzy neural network by the error between the predicted value and the actual value of dissolved oxygen concentration E_{f}(t_{f})=½[y_{f}(t_{f})−ŷ_{f}(t_{f})]²:

w_{fj}(t_{f+1})=w_{fj}(t_{f})−0.2∂E_{f}(t_{f})/∂w_{fj}(t_{f}) (31)

c_{fij}(t_{f+1})=c_{fij}(t_{f})−0.2∂E_{f}(t_{f})/∂c_{fij}(t_{f}) (32)

σ_{fij}(t_{f+1})=σ_{fij}(t_{f})−0.2∂E_{f}(t_{f})/∂σ_{fij}(t_{f}) (33)

where w_{fj}(t_{f+1}) is the weight between the jth regular layer neuron and the output layer neuron of the slow sampling fuzzy neural network at time t_{f+1}, c_{fij}(t_{f-1}) is the center of the ith input neuron corresponding to the jth radial basis function neuron of the fast sampling fuzzy neural network at time t_{f+1}, σ_{fij}(t_{f+1}) is the width of the ith input neuron corresponding to the jth radial basis function neuron of the fast sampling fuzzy neural network at time t_{f+1};

\textcircled{7} design an objective function of multi-time scale model predictive control to track the set-points of nitrate nitrogen concentration and dissolved oxygen concentration, and calculate the control law at time t_{f}:

J(t_{f})=0.25[[r_{f}(t_{f})−ŷ_{f}(t_{f})]^{T}[r(t_{f})−ŷ_{f}(t_{f})]+Δu(t_{f})^{T}Δu(t_{f})]+0.45[rₛ(t_{f})−ŷₛ(t_{f})]^{T}[rₛ(t_{f})−ŷₛ(t_{f})]+Δu(t_{f})^{T}Δu(t_{f}) (34)

where r_{f}(t_{f})=[r_{f}(t_{f-1}), r_{f}(t_{f+2}), r_{f}(t_{f+3})]^{T} is the set-point of dissolved oxygen concentration, r_{f}(t_{f+1})=2 mg/l represents the set-point of dissolved oxygen concentration at time t_{f+1}, r_{f}(t_{f+2})=2 mg/l represents the set-point of dissolved oxygen concentration at time t_{f+2}, r_{f}(t_{f+3})=2 mg/l represents the set-point of dissolved oxygen concentration at time t_{f+3}; ŷ_{f}(t_{f})=[ŷ_{f}(t_{f+1}), ŷ_{f}(t_{f+2}), ŷ_{f}(t_{f+3})]^{T} is the prediction output of the fast sampling fuzzy neural network, ŷ_{f}(t_{f-1}) is the prediction value of dissolved oxygen concentration at time t_{f+1}, ŷ_{f}(t_{f+2}) is the prediction value of dissolved oxygen concentration at time t_{f+2}, ŷ_{f}(t_{f+3}) is the prediction value of dissolved oxygen concentration at time t_{f+3}; rₛ(t_{f})=[rₛ(t_{f+1}), rₛ(t_{f+2}), rₛ(t_{f+3})]^{T} is the set-point of nitrate nitrogen concentration; rₛ(t_{f+1})=1 mg/l represents the set-point of nitrate nitrogen concentration at time t_{f+1}, rₛ(t_{f+2})=1 mg/l represents the set-point of nitrate nitrogen concentration at time t_{f+2}, rₛ(t_{f+3})=1 mg/l represents the set-point of nitrate nitrogen concentration at time t_{f+3}; ŷₛ(tₛ)=[ŷₛ(tₛ₊₁), ŷₛ(tₛ₊₂), ŷₛ(tₛ₊₃)]^{T} is the prediction output of slow sampling fuzzy neural network, ŷₛ(t_{f+1}) is the prediction value of nitrate nitrogen concentration at time t_{f+1}, ŷₛ(t_{f+2}) is the prediction value of nitrate nitrogen concentration at time t_{f+2}, ŷₛ(t_{f+3}) is the prediction value of nitrate nitrogen concentration at time t_{f+3}; Δu(t_{f})=[Δu₁(t_{f}), Δu₂(t_{f})]^{T} is the incremental control moves at time t_{f}, Δu₁(t_{f}) is the aeration rate adjustment amount at time t_{f}, Δu₂(t_{f}) is the internal reflux adjustment amount at time t_{f}, where

Δu(t_{f})=u(t_{f+1})−u(t_{f}) (35)

|Δu(t_{f})|≤Δuₘₐₓ (36)

u(t_{f})=[u₁(t_{f}), u₂(t_{f})]^{T} is control vector converting into analog signal through programmable logic controller and transmitting to variable frequency driver at time t_{f}, u(t_{f+1})=[u₁(t_{f+1}), u₂(t_{f-1})]^{T} is control vector converting into analog signal through programmable logic controller and transmitting to variable frequency driver at time t_{f+1}, u₁(t_{f+1}) is the aeration rate at time t_{f+1}, u₂(t_{f+1}) is the internal reflux at time t_{f+1}; Δuₘₐₓ=[ΔK_{L}aₘₐₓ, ΔQₐₘₐₓ]^{T} is the maximum adjustment vector allowed by the controller, ΔK_{L}aₘₐₓ=100 L/min is the maximum aeration adjustment amount, ΔQₐₘₐₓ=50000 L/min is the maximum internal reflux adjustment amount, Δuₘₐₓ is set through the blower and internal reflux valve in the control system equipment;

an aeration rate and internal reflux adjustment vector are calculated by minimizing Eq.(15):

$$Δ u ( {t}_{f} ) = ( 0. 4 {( \frac{\partial {\hat{y}}_{f} ( {t}_{f} )}{\partial u ( {t}_{f} )} )}^{T} [ {r}_{f} ( {t}_{f} ) - {\hat{y}}_{f} ( {t}_{f} ) ] + 0.08 {( \frac{\partial {\hat{y}}_{s} ( {t}_{f} )}{\partial u ( {t}_{f} )} )}^{T} [ {r}_{s} ( {t}_{f} ) - {\hat{y}}_{s} ( {t}_{f} ) ] ) \qquad ( 37 )$$

adjust the aeration rate and internal reflux at time t_{f}:

u(t_{f+1})=u(t_{f})+Δu(t_{f}) (38)

\textcircled{8} if f≤1000, increase the value of f by 1, increase the value of η by 1, go to step \textcircled{2}; if f>1000, end the cycle;

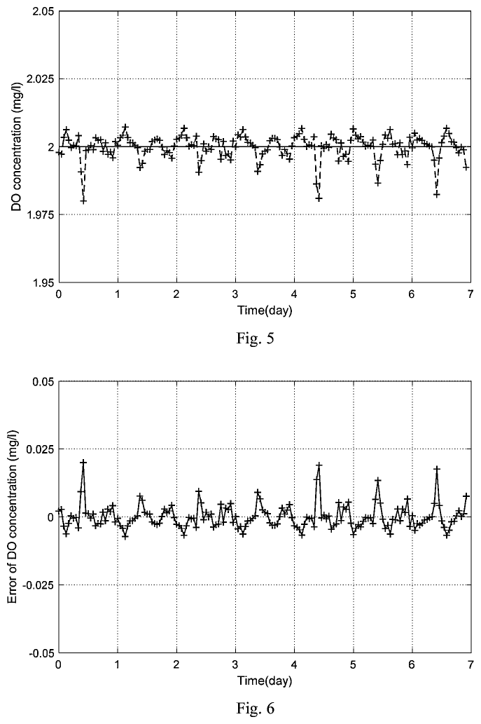

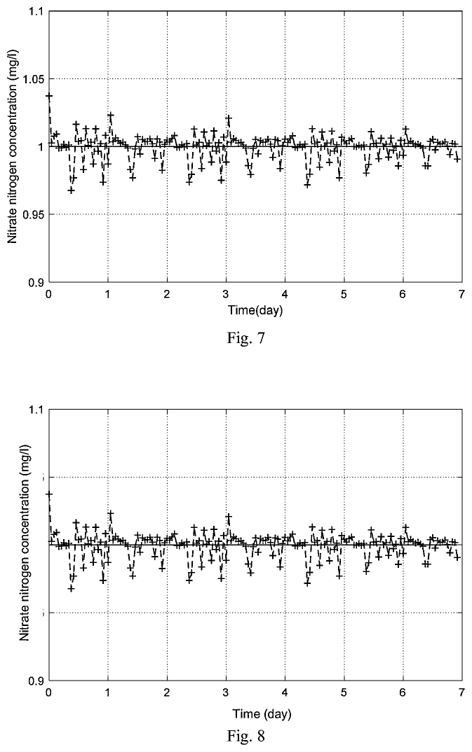

(6) the concentration of nitrate nitrogen and dissolved oxygen is controlled by u(t_{f}), and u(t_{f})=[u₁(t_{f}), u₂(t_{f})]^{T} is transferred to programmable logic controller for digital/analog conversion to obtain U(t_{f})=[U₁(t_{f}), U₂(t_{f})]^{T}, which is the input of variable-frequency drive, the variable-frequency drive changes the working power frequency of motor to control the aeration pump and electronic valve, then, the aeration rate and internal reflux are controlled, the output of the system is the actual value of nitrate nitrogen concentration and dissolved oxygen concentration. FIG. 4 shows the dissolved oxygen concentration of the system, X-axis: time, unit: day, Y-axis: dissolved oxygen concentration, unit: mg/L, the solid line is the expected dissolved oxygen concentration, the dotted line is the actual dissolved oxygen concentration; the error between the actual output dissolved oxygen concentration and the expected dissolved oxygen concentration is shown in FIG. 5, X-axis: time, unit: day, Y-axis: dissolved oxygen concentration error, unit: mg/L FIG. 6 shows the nitrate concentration value of the system, X-axis: time, unit: day, Y-axis: nitrate concentration value, unit: mg/L, solid line is expected nitrate concentration value, dotted line is actual nitrate concentration value; the error between actual output nitrate concentration and expected nitrate concentration is shown in FIG. 7, X-axis: time, unit: day, Y-axis: nitrate concentration error value, unit: mg/L. The results show that the method is effective.

What is claimed is:

1. A multi-time scale model predictive control method of wastewater treatment process, comprising the following steps:
(1) the multi-time scale model predictive control system for wastewater treatment process control comprising a set of measuring devices arranged to obtain a dataset, measuring devices include dissolved oxygen detector, nitrate nitrogen detector, the dataset comprises a plurality of process variables related to a parameter of wastewater treatment process; a programmable logic controller arranged to perform digital/analog conversion and analog/digital conversion; a variable-frequency drive arranged to control the air-blower and electronic valve by changing the working power frequency of motor; an air-blower arranged to provide the required oxygen to the microorganisms in the wastewater treatment process; an electronic valve arranged to adjust internal return flow; a multi-time scale model predictive control module arranged to calculate the control law to track the dissolved oxygen concentration and nitrate nitrogen concentration in wastewater treatment process with different time scales; the multi-time scale model predictive control module comprising two fuzzy neural network to predict the system outputs, a time scale conversion mechanism to unify the prediction time scales to fast time scale, and an optimization control module to calculate the control law;
(2) the time scales of dissolved oxygen concentration and nitrate nitrogen concentration in wastewater treatment process are different, specifically:
T_{f} is the sampling interval of dissolved oxygen concentration, T_{f}∈[6, 10] is a positive integer in minutes, t_{f}=fT_{f} represents the sampling instant of dissolved oxygen concentration, f is the number of sampling steps of dissolved oxygen concentration, and f∈[1, 1000] is a positive integer;
Tₛ is the sampling interval of nitrate nitrogen concentration, Tₛ∈[12, 20] is a positive integer in minutes, tₛ=sTₛ represents the sampling instant of nitrate nitrogen concentration, s is the number of sampling steps of nitrate nitrogen concentration, and s∈[1, 400] is a positive integer;
ζ is the maximum common divisor of T_{f} and Tₛ, t_{η}=ηζ is the prediction instant of slow sampling fuzzy neural network, η is the number of prediction steps of slow sampling fuzzy neural network, η∈[1, 2000] is a positive integer;
(3) a fast sampling fuzzy neural network is designed to predict dissolved oxygen concentration with time scale T_{f}, which is as follows:
the input of the fast sampling fuzzy neural network is x_{f}(t_{f})=[x_{f1}(t_{f-1}), x_{f2}(t_{f-1}), x_{f3}(t_{f-1})]^{T}, T is the transposition of the matrix, and the output of the fast sampling fuzzy neural network is the predicted value of dissolved oxygen concentration ŷ_{f}(t_{f}) at time t_{f}, the output is defined as follows
$${\hat{y}}_{f} ( {t}_{f} ) = \frac{{\sum }_{j = 1}^{6} {w}_{fj} ( {t}_{f} ) {e}^{- {\sum }_{i = 1}^{3} \frac{{( {x}_{fi} ( {t}_{f} - 1 ) - {c}_{fij} ( {t}_{f} ) )}^{2}}{2 {σ}_{fij}^{2} ( {t}_{f} )}}}{{\sum }_{j = 1}^{6} {e}^{- {\sum }_{i = 1}^{3} \frac{{( {x}_{fi} ( {t}_{f} - 1 ) - {c}_{fij} ( {t}_{f} ) )}^{2}}{2 {σ}_{fij}^{2} ( {t}_{f} )}}} \qquad ( 1 )$$
where x_{fi}(t_{f-1}) is the ith input of the fast sampling fuzzy neural network at time t_{f}, i=1, 2, 3, w_{fj}(t_{f}) is the weight between the jth regular layer neuron and the output layer neuron of the fast sampling fuzzy neural network at time t_{f}, w_{fj}(t₀) is randomly assigned within [0, 1], j=1, 2, 3, 4, 5, 6, t₀ is the initial instant, c_{fij}(t_{f}) is the center of the ith input neuron corresponding to the jth radial basis function neuron of the fast sampling fuzzy neural network at time t_{f}, c_{fij}(t₀) is randomly assigned within [0,1], σ_{fij}(t_{f}) is the width of the ith input neuron corresponding to the jth radial basis function neuron of the fast sampling fuzzy neural network at time t_{f}, and σ_{fij}(t₀) is randomly assigned within [0,1];
(4) a slow sampling fuzzy neural network is designed to predict nitrate nitrogen concentration with time scale ζ, which is as follows:
The input of the slow sampling fuzzy neural network is xₛ(t_{η})=[xₛ₁(t_{η-1}), xₛ₂(t_{η-1}), xₛ₃(t_{η-1})]^{T}, and the output of the slow sampling fuzzy neural network is the predicted value of nitrate nitrogen concentration ŷₛ(t_{η}) at time t_{η}, the output is defined as follows
$${\hat{y}}_{f} ( {t}_{η} ) = \frac{{\sum }_{j = 1}^{6} {ω}_{sj} ( {t}_{η} ) {e}^{- {\sum }_{i = 1}^{3} \frac{{( {x}_{si} ( {t}_{η} - 1 ) - {c}_{sij} ( {t}_{η} ) )}^{2}}{2 {σ}_{sij}^{2} ( {t}_{η} )}}}{{\sum }_{j = 1}^{6} {e}^{- {\sum }_{i = 1}^{3} \frac{{( {x}_{si} ( {t}_{η} - 1 ) - {c}_{sij} ( {t}_{η} ) )}^{2}}{2 {σ}_{sij}^{2} ( {t}_{η} )}}} \qquad ( 2 )$$
where xₛᵢ(t_{η-1}) is the ith input of the slow sampling fuzzy neural network at time t_{η}, wₛⱼ(t_{η}) is the weight between the jth regular layer neuron and the output layer neuron of the slow sampling fuzzy neural network at time t_{η}, wₛⱼ(t₀) is randomly assigned within [0, 1], cₛᵢⱼ(t_{η}) is the center of the ith input neuron corresponding to the jth radial basis function neuron of the slow sampling fuzzy neural network at time t_{η}, cₛᵢⱼ(t₀) is randomly assigned within [0,1], σₛᵢⱼ(t_{η}) is the width of the ith input neuron corresponding to the jth radial basis function neuron of the slow sampling fuzzy neural network at time t_{η}, and σₛᵢⱼ(t₀) is randomly assigned within [0,1];
a dataset Ω whose time scale is ζ is constructed as follows, when tₛ≤t_{η}<tₛ₊₁:
uₛ₁^{η}(t_{η})=uₛ₁(tₛ) (3)
uₛ₂^{η}(t_{η})=uₛ₂(tₛ) (4)
yₛ^{η}(t_{η})=yₛ(tₛ)+Tₛ(yₛ(tₛ₊₁)−yₛ(tₛ))/t_{η} (5)
where uₛ₁^{η}(t_{η}) is the virtual value of aeration rate at time t_{η}, uₛ₁(tₛ) is the actual value of aeration rate at time tₛ, uₛ₂^{η}(t_{η}) is the virtual value of internal reflux at time t_{η}, uₛ₂(tₛ) is the actual value of internal reflux at time tₛ, yₛ^{η}(t_{η}) is the virtual estimated value of nitrate nitrogen concentration at time t_{η}, yₛ(tₛ) is the actual value of the nitrate nitrogen concentration converted by the programmable logic controller at time tₛ, yₛ(tₛ₊₁) is the actual value of the nitrate nitrogen concentration converted by the programmable logic controller at time tₛ₊₁; the dataset Ω is composed of uₛ₁^{η}(t_{η}), uₛ₂^{η}(t_{η}), and yₛ^{η}(t_{η});
The dataset Ω is used to pre-train the slow sampling fuzzy neural network offline, and the training input is xₛ^{η}(t_{η})=[yₛ^{η}(t_{η-1}), uₛ₁^{η}(t_{η-1}), uₛ₂^{η}(t_{η-1})]^{T}, yₛ^{η}(t_{η-1}) is the nitrate nitrogen concentration at time t_{η-1} in Ω, uₛ₁^{η}(t_{η-1}) is the aeration rate at time t_{η-1} in Ω, uₛ₂^{η}(t_{η-1}) is the internal reflux at time t_{η-1} in Ω, the training output is the prediction value of nitrate nitrogen concentration ŷₛ^{η}(t_{η}) at time t_{η}; using the error between nitrate nitrogen concentration value in dataset Ω and predicted value Eₛ^{η}(t_{η})=½[yₛ^{η}(t_{η})−ŷₛ^{η}(t_{η})]² at time t_{η}, correct parameters of slow sampling fuzzy neural network:
wₛⱼ(t_{η+1})=wₛⱼ(t_{η})−0.2∂Eₛ^{η}(t_{η})/∂wₛⱼ(t_{η}) (6)
cₛᵢⱼ(t_{η+1})=cₛᵢⱼ(t_{η})−0.2∂Eₛ^{η}(t_{η})/∂cₛᵢⱼ(t_{η}) (7)
σₛᵢⱼ(t_{η+1})=σₛᵢⱼ(t_{η})−0.2∂Eₛ^{η}(t_{η})/∂σₛᵢⱼ(t_{η}) (8)
where wₛⱼ(t_{η+1}) is the weight between the jth regular layer neuron and the output layer neuron of the slow sampling fuzzy neural network at time t_{η+1}, cₛᵢⱼ(t_{η+1}) is the center of the ith input neuron corresponding to the jth radial basis function neuron of the slow sampling fuzzy neural network at time t_{η+1}, σₛᵢⱼ(t_{η+1}) is the width of the ith input neuron corresponding to the jth radial basis function neuron of the slow sampling fuzzy neural network at time t_{η+1;}
(5) The multi-time scale model predictive control method is designed to control the dissolved oxygen concentration and nitrate nitrogen concentration in time scale T_{f}, specifically:
\textcircled{1} set s=1, f=1, η=1;
\textcircled{2} according to the sampling information converted by programmable logic controller, predict nitrate nitrogen concentration at time t_{η} using slow sampling fuzzy neural network; the inputs of the slow sampling fuzzy neural network are as follows: xₛ₁(t_{η-1}) is the actual value of nitrate nitrogen concentration yₛ(t_{η-1}) at time t_{η-1}, xₛ₂(t_{η-1}) is the aeration rate u₁(t_{η-1}) at time t_{η-1}, xₛ₃(t_{η-1}) is the internal reflux u₂(t_{η-1}) at time t_{η-1}; the output of the slow sampling fuzzy neural network is the prediction value of nitrate nitrogen concentration ŷₛ(t_{η}) at time t_{η};
\hat{3} if t_{η}=t_{f}, set ŷₛ(t_{f})=ŷₛ(t_{η}), where ŷₛ(t_{f}) is the prediction value of nitrate nitrogen concentration at time t_{f}, go to step \textcircled{6} after performing step \textcircled{4}; if t_{η}≠t_{f}, go to step \textcircled{6} after performing step \textcircled{5};
\textcircled{4} if t_{η}=tₛ, increase the value of s by 1, update the parameters of the slow sampling fuzzy neural network by the error between the predicted value and the actual value of nitrate nitrogen concentration Eₛ(t_{η})=½[yₛ(tₛ)−ŷₛ(t_{η})]²:
wₛⱼ(t_{η+1})=wₛⱼ(t_{η}))−0.2∂Eₛ(t_{η})/∂wₛⱼ(t_{η}) (9)
cₛᵢⱼ(t_{η+1})=cₛᵢⱼ(t_{η})−0.2∂Eₛ(t_{η})/∂cₛᵢⱼ(t_{η}) (10)
σₛᵢⱼ(t_{η+1})=σₛᵢⱼ(t_{η})−0.2∂Eₛ(t_{η})/∂σₛᵢⱼ(t_{η}) (11)
if t_{η}≠tₛ, the parameters of slow sampling fuzzy neural network are not updated;
\hat{5} set yₛ(t_{η})=ŷₛ(t_{η}), u₁(t_{η})=u₁(t_{f}), u₂(t_{η})=u₂(t_{f}), increase the value of η by 1, go to step \textcircled{2}, where yₛ(t_{η}) is the actual nitrate nitrogen concentration converted by the programmable logic controller at time t_{η}, u₁(t_{η}) is the aeration rate at time t_{η}, u₂(t_{η}) is the internal reflux at time t_{η}, u₁(t_{f}) is the aeration rate at time t_{f}, u₂(t_{f}) is the internal reflux at time t_{f};
\hat{6} predict dissolved oxygen concentration at time t_{f} by the fast sampling fuzzy neural network; the inputs of the fast sampling fuzzy neural network are as follows: x_{f1}(t_{f-1}) is the actual value of dissolved oxygen concentration y_{f}(t_{f-1}) converted by the programmable logic controller at time t_{f-1}, x_{f2}(t_{f-1}) is the aeration rate u₁(t_{f-1}) at time t_{f-1}, x_{f3}(t_{f-1}) is the internal reflux u₂(t_{f-1}) at time t_{f-1}; the output of the fast sampling fuzzy neural network is the prediction value of dissolved oxygen concentration ŷ_{f}(t_{f}) at time t_{f}; update the parameters of the fast sampling fuzzy neural network by the error between the predicted value and the actual value of dissolved oxygen concentration E_{f}(t_{f})=½[y_{f}(t_{f})−ŷ_{f}(t_{f})]²:
w_{fj}(t_{f+1})=w_{fj}(t_{f})−0.2∂E_{f}(t_{f})/∂w_{fj}(t_{f}) (12)
c_{fij}(t_{f+1})=c_{fij}(t_{f})−0.2∂E_{f}(t_{f})/∂c_{fij}(t_{f}) (13)
σ_{fij}(t_{f+1})=σ_{fij}(t_{f})−0.2∂E_{f}(t_{f})/∂σ_{fij}(t_{f}) (14)
where w_{fj}(t_{f+1}) is the weight between the jth regular layer neuron and the output layer neuron of the slow sampling fuzzy neural network at time t_{f+1}, c_{fij}(t_{f+1}) is the center of the ith input neuron corresponding to the jth radial basis function neuron of the fast sampling fuzzy neural network at time t_{f+1}, σ_{fij}(t_{f+1}) is the width of the ith input neuron corresponding to the jth radial basis function neuron of the fast sampling fuzzy neural network at time t_{f+1};
\textcircled{7} design an objective function of multi-time scale model predictive control to track the set-points of nitrate nitrogen concentration and dissolved oxygen concentration, and calculate the control law at time t_{f}:
J(t_{f})=0.25[[r_{f}(t_{f})−ŷ_{f}(t_{f})]^{T}[r_{f}(t_{f})−ŷ_{f}(t_{f})]+Δu(t_{f})^{T}Δu(t_{f})]+0.45[rₛ(t_{f})−ŷₛ(t_{f})]^{T}[rₛ(t_{f})−ŷₛ(t_{f})]Δu(t_{f})^{T}Δu(t_{f}) (15)
where r_{f}(t_{f})=[r_{f}(t_{f+1}), r_{f}(t_{f+2}), r_{f}(t_{f+3})]^{T} is the set-point of dissolved oxygen concentration, r_{f}(t_{f+1})=2 mg/l represents the set-point of dissolved oxygen concentration at time t_{f+1}, r_{f}(t_{f+2})=2 mg/l represents the set-point of dissolved oxygen concentration at time t_{f+2}, r_{f}(t_{f+3})=2 mg/l represents the set-point of dissolved oxygen concentration at time t_{f+3}; ŷ_{f}(t_{f})=[ŷ_{f}(t_{f+1}), ŷ_{f}(t_{f+2}), ŷ_{f}(t_{f+3})]^{T} is the prediction output of the fast sampling fuzzy neural network, ŷ_{f}(t_{f+1}) is the prediction value of dissolved oxygen concentration at time t_{f+1}, ŷ_{f}(t_{f+2}) is the prediction value of dissolved oxygen concentration at time t_{f+2}, ŷ_{f}(t_{f+3}) is the prediction value of dissolved oxygen concentration at time t_{f+3}; rₛ(t_{f})=[rₛ(t_{f+1}), rₛ(t_{f+2}), rₛ(t_{f+3})]^{T} is the set-point of nitrate nitrogen concentration; rₛ(t_{f+1})=1 mg/l represents the set-point of nitrate nitrogen concentration at time t_{f+1}, rₛ(t_{f+2})=1 mg/l represents the set-point of nitrate nitrogen concentration at time t_{f+2}, rₛ(t_{f+3})=1 mg/l represents the set-point of nitrate nitrogen concentration at time t_{f+3}; ŷₛ(tₛ)=[ŷₛ(tₛ₊₁), ŷₛ(tₛ₊₂), ŷₛ(tₛ₊₃)]^{T} is the prediction output of slow sampling fuzzy neural network, ŷₛ(t_{f-1}) is the prediction value of nitrate nitrogen concentration at time t_{f+1}, ŷₛ(t_{f+2}) is the prediction value of nitrate nitrogen concentration at time t_{f+2}, ŷₛ(t_{f+3}) is the prediction value of nitrate nitrogen concentration at time t_{f+3}; Δu(t_{f})=[Δu₁(t_{f}), Δu₂(t_{f})]^{T} is the incremental control moves at time t_{f}, Δu₁(t_{f}) is the aeration rate adjustment amount at time t_{f}, Δu₂(t_{f}) is the internal reflux adjustment amount at time t_{f}, where
Δu(t_{f})=u(t_{f+1})−u(t_{f}) (16)

|Δu(t_{f})|≤Δuₘₐₓ (17)
u(t_{f})=[u₁(t_{f}), u₂(t_{f})]^{T} is control vector converting into analog signal through programmable logic controller and transmitting to variable frequency driver at time t_{f}, u(t_{f+1})=[u₁(t_{f+1}), u₂(t_{f+1})]^{T} is control vector converting into analog signal through programmable logic controller and transmitting to variable frequency driver at time t_{f+1}, u₁(t_{f+1}) is the aeration rate at time t_{f+1}, u₂(t_{f+1}) is the internal reflux at time t_{f+1}; Δuₘₐₓ=[ΔK_{L}aₘₐₓ, ΔQₐₘₐₓ]^{T} is the maximum adjustment vector allowed by the controller, ΔK_{L}aₘₐₓ=100 L/min is the maximum aeration adjustment amount, ΔQₐₘₐₓ=50000 L/min is the maximum internal reflux adjustment amount, Δuₘₐₓ is set through the blower and internal reflux valve in the control system equipment;
an aeration rate and internal reflux adjustment vector are calculated by minimizing Eq.(15):
$$Δ u ( {t}_{f} ) = ( 0. 4 {( \frac{\partial {\hat{y}}_{f} ( {t}_{f} )}{\partial u ( {t}_{f} )} )}^{T} [ {r}_{f} ( {t}_{f} ) - {\hat{y}}_{f} ( {t}_{f} ) ] + 0.08 {( \frac{\partial {\hat{y}}_{s} ( {t}_{f} )}{\partial u ( {t}_{f} )} )}^{T} [ {r}_{s} ( {t}_{f} ) - {\hat{y}}_{s} ( {t}_{f} ) ] ) \qquad ( 18 )$$
adjust the aeration rate and internal reflux at time t_{f}:
u(t_{f+1})=u(t_{f})+Δu(t_{f}) (19)
\textcircled{8} if f≤1000, increase the value of f by 1, increase the value of η by 1, go to step \textcircled{2}; if f>1000, end the cycle;
(6) the concentration of nitrate nitrogen and dissolved oxygen is controlled by u(t_{f}), and u(t_{f})=[u₁(t_{f}), u₂(t_{f})]^{T} is transferred to programmable logic controller for digital/analog conversion to obtain U(t_{f})=[U₁(t_{f}), U₂(t_{f})]^{T}, which is the input of variable-frequency drive, the variable-frequency drive changes the working power frequency of motor to control the aeration pump and electronic valve, then, the aeration rate and internal reflux are controlled, the output of the system is the actual value of nitrate nitrogen concentration and dissolved oxygen concentration.
